(19) United States
(12) Patent Application Publication
(10) Pub. No.: US 2018/0075233 A1
(43) Pub. Date: Mar. 15, 2018

(54) SYSTEMS AND METHODS FOR AGENT-BASED DETECTION OF HACKING ATTEMPTS

(71) Applicant: Veracode, Inc., Burlington, MA (US)

(72) Inventor: Scott Matthew Gray, Milford, NH (US)

(73) Assignee: Veracode, Inc., Burlington, MA (US)

(21) Appl. No.: 15/263,708

(22) Filed: Sep. 13, 2016

(51) Int. Cl. G06F 21/54; G06F 21/55

(52) U.S. Cl. CPC G06F 21/54; G06F 2221/034; G06F 21/554

(57) ABSTRACT

In a system for protecting user accessible software applications, an application is executed in coordination with a security agent, and the security agent can monitor communications between users and the application. By analyzing one or more automation characteristics of the communications, and by comparing and contrasting these characteristics with those of known security scanners, the agent can determine whether the communication is likely associated with a malicious user. The agent can also monitor whether a communication attempts to change the value of a decoy unit, and can designate such communication as associated with a likely malicious user. By analyzing the contents of the communication, the agent can designate a threat level to the communication. The agent can block the communications likely associated with malicious users and/or having a designated high threat level, or can alert a system administrator, to protect the software application.

### FIELD OF THE INVENTION

This disclosure generally relates to protecting software applications/systems from hacking attempts and, more particularly, to systems and methods for identifying such attempts by monitoring the communications associated with a software application/system, using an agent.

### BACKGROUND OF THE INVENTION

Many software applications are configured to receive information or data from users, to process such data, and to provide results of the analysis to the user. For example, a search engine can receive words and phrases and can return content items matching those words and phrases. A mapping-based service can receive geographical address in the form of text (e.g., street name and/or town-name, zip code, etc.), in the form of GPS data, as Internet address, etc., and can show the location of that address on a map. The mapping-based service can provide additional information, such as directions to the specified location, other useful services available in the vicinity such as gas stations, restaurants, etc. Users can also provide personally identifiable information in some cases, and obtain services such as refilling a prescription, authorizing a payment, etc.

Allowing software applications to receive data/information from users can facilitate the above-described input/output behavior of software applications, which can be highly beneficial to legitimate users. This, however, can also make the software application vulnerable. Specifically, malicious users can send data and/or requests to expose flaws/defects that commonly exist in software systems, and can then send additional data and/or requests to gain unauthorized access to the software, to control the behavior of the software, and/or to access user information and other sensitive data associated with the software, without authorization.

Static and/or dynamic vulnerability analysis and/or defect identification techniques that can analyze the source code and/or one or more compiled binary files corresponding to a software application can be used to detect flaws/defects in the software, and such defects can then be remedied. Alternatively, or in addition, the software application can be protected by a firewall that authenticates users and may allow access to the application only to the users determined to be authorized. A comprehensive static and/or dynamic analysis of many software applications is not always performed and, some defects can remain undetected even after performing such an analysis. Some malicious users can gain access to a software application through a firewall or by bypassing the firewall. For examples, some firewall may not provide protection against structure query language (SQL) injection attacks. Also, to maximize the beneficial use of the software application, it is sometimes necessary not to protect the application with a firewall.

### SUMMARY OF THE INVENTION

In various embodiments, to protect a software application (the terms application, system, and program are used interchangeably), a security agent, which is another software program separate from the application to be protected, is executed concurrently with the program to be protected. Using certain rules, the agent can determine one or more entry locations where the application to be protected can receive data from external sources including users. The agent can then insert (also called instrument) additional code that can monitor the data exchanged by the application to be protected. By analyzing such data, the agent can determine whether a likely legitimate user is attempting to communicate or interact with the application to be protected or whether the communications are associated with a likely malicious user.

The agent may use a decoy mechanism (also called a honeypot) where communications from a legitimate user would typically ignore the decoy, but a malicious user may change a value associated with the decoy. As such, the decoy mechanism can be used in addition to monitoring other communication, or in the alternative, to determine whether a user communicating with the application to be protected is likely legitimate or likely malicious. After determining that a likely malicious user is attempting to communicate with the application to be protected, the agent can take an appropriate action such as alerting a system administrator, blocking the communications, etc.

Static and/or dynamic analysis of software systems is typically performed off-line, during a testing phase, and prior to deployment of the software systems. Various embodiments of the security agent can protect applications to be protected after they are deployed and while they are running and are in use. These embodiments can provide protection whether or not a firewall is used. Firewalls are generally not customized for the applications they protect. Unlike firewalls, various embodiments of the security agent analyze specific entry locations of the application to be protected and can thus provide customized protection.

Accordingly, in one aspect, a method is provided for detecting attacks on a software application. The method includes the steps of: loading a software agent (also called a security agent or a software security agent) in a runtime environment, and instrumenting by the software agent, in the runtime environment, one or more components of a software application. One or more of the instrumented component(s) may include an entry point into the software application. The method also includes causing execution of the software application, and intercepting by the software agent a communication corresponding to the software application. In addition, the method includes analyzing by the software agent a threat severity of the communication based on: (i) whether the communication is associated with a scanner, and/or (ii) whether the communication is associated with a decoy unit.

The software agent may include one or more rules and a code fragment. The rule(s) may be configured to detect entry points in a software application. The component of the software application may include an entry point. At least one of the one or more rules may be configured to detect the entry point in the component, and instrumenting the component may include inserting, by the software agent, the code fragment in association with the entry point. For example, the code fragment may be inserted at or near (e.g., a few, such as 1, 2, 5, 10, etc., executable statements before or after) the location of the entry point in the software application.

In some embodiments, the communication includes a request received by the software application and/or a response generated by the software application. The software agent may determine that the communication is associated with a software scanner. As such, analyzing the threat severity may include assigning a designated low or a medium threat level to the communication. In some cases, the software agent may determine that the communication is not associated with a scanner, and analyzing the threat severity may include assigning a designated medium or high threat level to the communication.

In some embodiments the communication is associated with a decoy unit. The software agent may determine this and, as such, analyzing the threat severity may include assigning a threat level to the communication based on, at least in part, an attempted change in a value corresponding to the decoy unit. To this end, the method may include detecting the attempted change in the value corresponding to the decoy unit.

The value corresponding to the decoy unit may include a persistent value, and detecting the attempted change may include determining that the communication associated with the decoy unit includes a value different from the persistent value. For example, the communication may attempt to set a new value that is different from the persistent value. In some embodiments, the value corresponding to the decoy unit includes a programmatically computed value, such as a value generated using an algorithm known to the software security agent but not likely known by other uses, including malicious uses. Detecting the attempted change may include determining that the communication associated with the decoy unit includes a value different from the programmatically computed value. The decoy unit may include a cookie unrelated to business logic of the software application and an interactive service unrelated to such business logic.

In some embodiments, the method includes instantiating by the software agent, in the runtime, the decoy unit in association with the software application. The method may include blocking the communication based on, at least in part, a threat level assigned to the communication by the software agent.

In another aspect, a computer system includes a first processor and a first memory coupled to the first processor. The first memory includes instructions which, when executed by a processing unit that includes the first processor and/or a second processor, program the processing unit, that is in electronic communication with a memory module that includes the first memory and/or a second memory, to detect attacks on a software application. To this end, the instructions program the processing unit to: load a software agent (also called a security agent or a software security agent) in a runtime environment, and instrument by the software agent, in the runtime environment, one or more components of a software application. One or more of the instrumented component(s) may include an entry point into the software application. The instructions also program the processing unit to initiate execution of the software application, and to intercept, by the software agent, a communication corresponding to the software application. In addition, the instructions program the processing unit to analyze by the software agent a threat severity of the communication based on: (i) whether the communication is associated with a scanner, and/or (ii) whether the communication is associated with a decoy unit. In various embodiments, the instructions can program the processing unit to perform one or more of the method steps described above.

In another aspect, an article of manufacture that includes a non-transitory storage medium has stored therein instructions which, when executed by a processing unit program the processing unit, which is in electronic communication with a memory, to detect attacks on a software application. To this end, the instructions program the processing unit to: load a software agent (also called a security agent or a software security agent) in a runtime environment, and instrument by the software agent, in the runtime environment, one or more components of a software application. One or more of the instrumented component(s) may include an entry point into the software application. The instructions also program the processing unit to initiate execution of the software application, and to intercept, by the software agent, a communication corresponding to the software application. In addition, the instructions program the processing unit to analyze by the software agent a threat severity of the communication based on: (i) whether the communication is associated with a scanner, and/or (ii) whether the communication is associated with a decoy unit. In various embodiments, the stored instructions can program the processor to perform one or more of the method steps described above.

### BRIEF DESCRIPTION OF THE DRAWINGS

Various embodiments of the present invention taught herein are illustrated by way of example, and not by way of limitation, in the FIGURES of the accompanying drawings, in which:

FIG. 1 schematically depicts a system and a process for protecting a software application using an agent, according to various embodiments.

### DETAILED DESCRIPTION

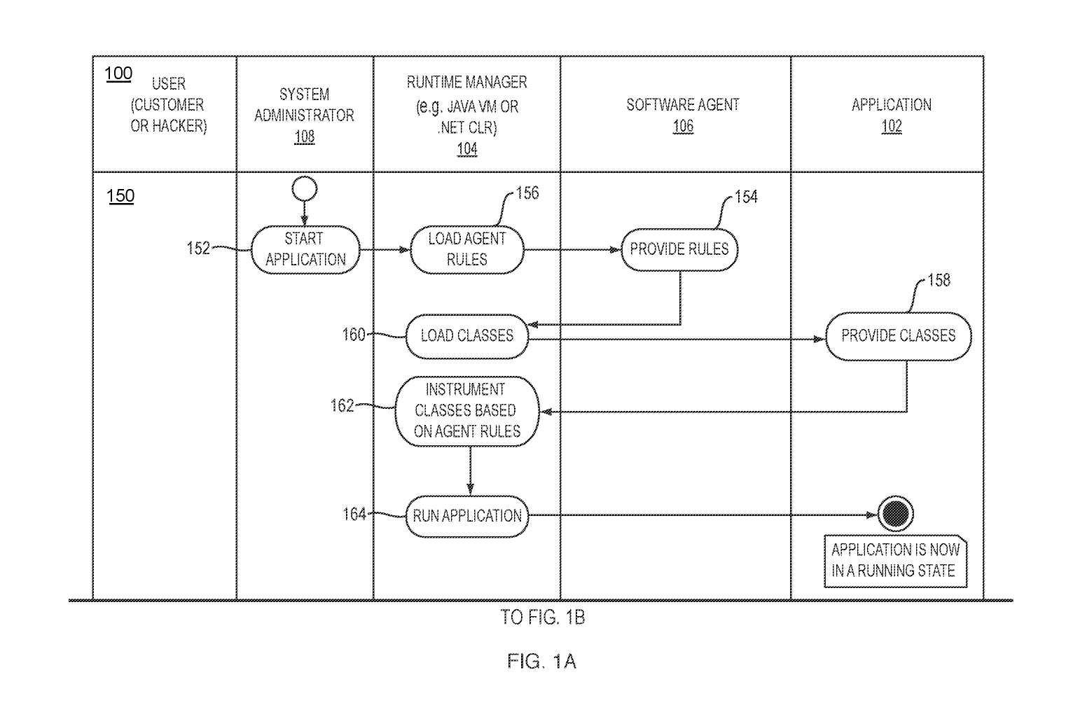

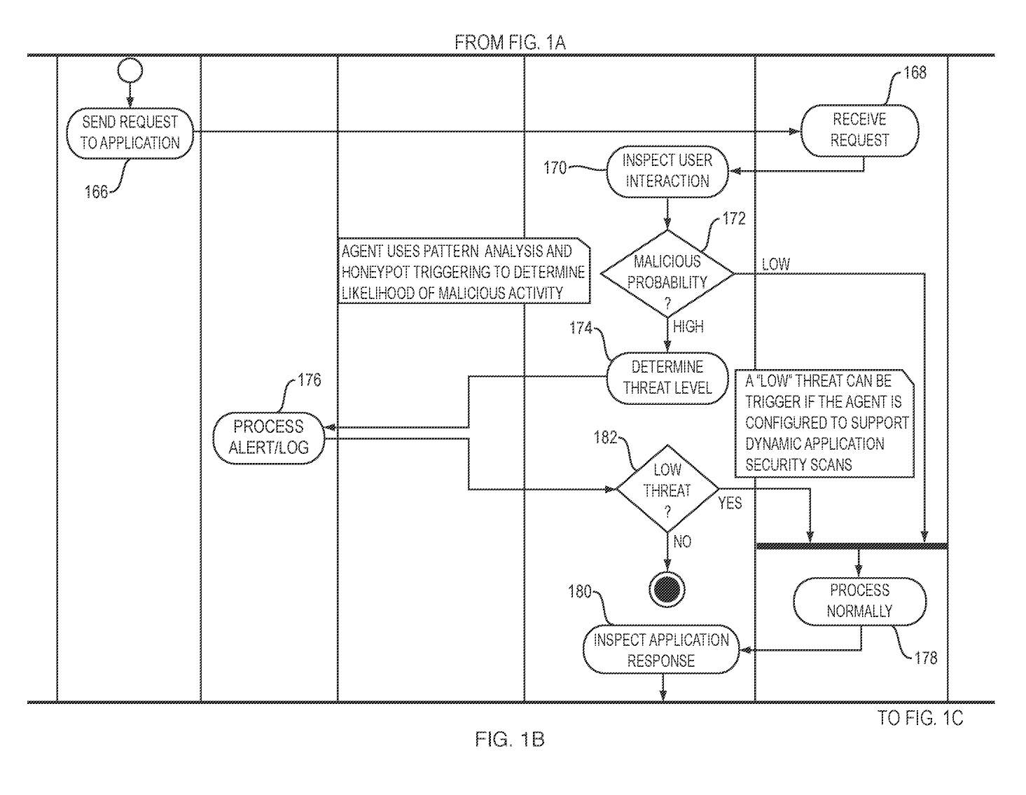

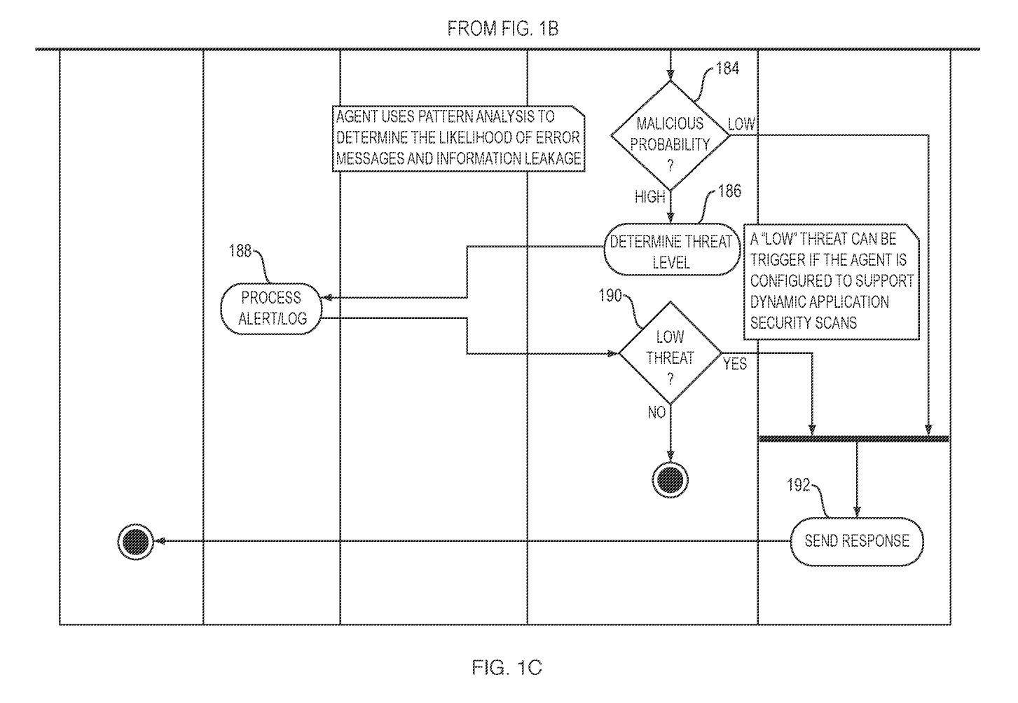

With reference to FIG. 1, in a software application protection system 100, a software application 102 that is to be protected can be executed using a runtime manager 104. The application 102 can be a web application, a desktop application, a mobile app, a standalone app, or a headless app (i.e., an app that does not require or implement a graphical user interface). In general, the application 102 can be any application that can be instrumented and have its entry locations determined. A security agent 106 is also executed concurrently with the application 102. To this end, a system administrator 108 can start the application 102 with the security agent 106 enabled. When the application is started, various modules and/or components thereof, such as classes, are loaded by the runtime manager 104. The agent 106 includes certain rules and code fragments, and can provide these rules and/or code fragments to the runtime manager 104. The runtime manager 104 instruments one or more of those code fragments into the code of the application 102, according to the specified rules. In general, the rules may be used to identify one or more entry locations into the application to be protected or analyzed, and the instrumentation can inject agent specific code at those locations, to monitor the data exchange that can occur at, and following, the entry locations. In various embodiments, the injected code analyzes the requested data for patterns and anomalies, and may perform specified actions based on that analysis. As such, conceptually, the processing of the software application can be considered to be interrupted by the agent that performs an alternative flow of execution.

For instrumentation, the source code is generally not needed. In some embodiments, the agent's intermediate code is injected during the loading of the application's intermediate code (e.g. Bytecode for JAVA and Intermediate Language (IL) for .NET) based on the rules identified by the agent 106. In some embodiments, the agent code is instrumented by runtimes executing executables (e.g., executables obtained from C, C++, etc.), where these is no intermediate code. For languages like C or C++, typically the rules specified in the agent are applied prior to or during the build process, which generally requires access to the source code of the application. For languages that have intermediate code the agent can be added after the build process and, as such, access to the source code may not be required. For example, a rule specified in the agent 106 may require monitoring of the methods of the Hypertext Transfer Protocol (HTTP) and, accordingly, during the initialization of an application that was written to use JAVA Servlet technology, the JAVA Virtual Machine (JVM) class loader (which can be a part of the runtime manager 104) can intercept classes of the application 102 that extend HttpServlet class. The JVM may inject one or more code fragments specified in the agent 106 into the “do” methods (e.g., the doGet and doPost methods) of the application 102. These methods are common entry locations into software applications using the HTTP. In some other applications, the rules of the agent 106 can identify one or more of the GET, POST, PUT, DELETE, and OPTIONS methods as entry locations. These methods may be also instrumented in applications supporting RESTful calls. For example, the JVM may inject one or more code fragments specified in the agent 106 into a REST-based Java application following the building of a WebResource using the Jersey framework.

In general, in a process 150, also described with reference to FIG. 1, the application to be protected 102 is started at step 152. Software security agent 106 provides the rules and/or code fragments at step 154. In some embodiments, the runtime manager 104 loads one or more rules of the agent 106 at step 156. At step 158, the application 102 provides its components (e.g., classes, in some embodiments), and the runtime manager 104 loads those components at step 160. At step 162, the runtime manager 104 uses the rules provided by the agent 106, and instruments the classes of the application 102 using the code fragments of the software security agent 106. The execution of the application 102, along with the instrumented code, starts at step 164.

At step 166, a user, which can be a legitimate user or a malicious user (such as a hacker) may send information (also called data) to the application 102. The information can be a query or a request, or other information such as interaction with input fields in a form displayed on a webpage (if the application 102 is a web application), or a form displayed in a user interface on a user device. The application 102 may receive the information/request at step 168, and the security agent 106 would intercept this communication or interaction between the user and the application 102 to be protected at step 170. For example, if “do” methods of a JAVA Servlet-based application 102 are instrumented, as described above, an HttpServletRequest object containing information from the HTTP Request may be analyzed. As another example, if the handler (e.g., onEditorAction) for text entry (e.g., using a TextView) in an Android™ application is called with the intent to send (e.g., invoking EditorInfo.IME_ACTION_SEND) and a user supplied data to a remote server, the software security agent 106 can intercept that data and analyze it for malicious content. If a user inputs freeform text (e.g., TextBox Control) for a C# .NET application, the software security agent 106 can add and/or augment an event handler (e.g., textBoxName_Validating) for validating the user input and may analyze it further for malicious content.

By analyzing the nature of the information and/or data contained in the overall communication and/or the request, the security agent can determine at step 172 whether the communication should be designated as malicious. To this end, the security agent 106 may particularly determine at step 172 whether the request/communication is received from a legitimate security scanner that is not a malicious user. A security scanner can scan the application 102 and perform static and/or dynamic analysis thereof, to detect any vulnerabilities, flaws, and/or defects therein. In some embodiments, a determination that a request/communication was received from a potentially legitimate security scanner can be made by identifying custom HTTP Request headers set by the scanner. For example, some vulnerability scanners generally have the same values and headers on all requests (e.g., Accept header will often be “*/*,” etc.). Other scanners often self identify themselves on the user-agent header (e.g., SiteLock will include SiteLockSpider in its list of user agents).

It should be noted that headers can be set to mimic a known vulnerability scanner; therefore, this technique can be beneficially used in conjunction with other assessments (e.g., known Internet Protocol (IP) ranges and scanning windows). A scanning window may be a time period defined by start and stop times agreed upon by the owner/vendor/provider of the application and the scanning provider, for the purpose of conducting a scan during that time period. For example, an app owner/vendor/provider may permit scanning of its website between the hours of midnight and 5 a.m. on certain days because usage of the app is generally low during this time period. In some cases, IP address ranges for the user associated with the communication are identified. If the detected IP address ranges correspond to IP address ranges that are known to be associated with good scans from authorized scanning-service providers, the request/communication may be designated as legitimate or having a low likelihood of being associated with a malicious user.

In some cases certain automation characteristics of the communication/requests can be used to determine whether the communication/request is received from a legitimate scanner or from a malicious user. Examples of such automation characteristics include extremely short timing between requests (e.g., requests that are a fraction of a millisecond apart or a few, tens, or hundreds of milliseconds apart) from same origin (i.e., from the same IP address), incremental/sequential values provided as inputs to forms or as other parameters such as query parameters (e.g., integers values such as 1, 2, 3, . . . , or character combinations with an increasing number such as abc1, abc2, abc3, . . . , etc.), port numbers tried in an incremental manner (e.g. 80, 81, 82, etc.), common port numbers tried in a sequential manner (e.g., 80, 443, etc.), common probe values, etc. A legitimate user is not highly likely to provide a series of incremental or sequential values and, as such, incremental/sequential values, port numbers, and common probes strongly indicate that a vulnerability scanner is being used. The scanner can be a genuine vulnerability scanner from a trusted provider or a scanner from a malicious user. To distinguish between the two, in various embodiments, IP ranges, time of scan, probe values, etc. can be analyzed, as well. Since all of these parameters can be spoofed the combinations of characteristics may be used to increase the likelihood of detecting a malicious attack. Specifically, a malicious user can imposter a beneficial scan by sending requests that have an automation characteristic of a legitimate scanner. For example, malicious users often use common port scanners and crawlers. To distinguish such malicious users from genuine scanners, some embodiments consider a combination of two or more automation characteristics, because it is less likely that a malicious user would mimic several different automation characteristics of a legitimate scanner. For example, a malicious user may set the user-agent to a trusted provider (say “TP_A”), but may not be able to effectively spoof the actual trusted provider's IP address, or may not set some of the other headers in the typical fashion in which the actual trusted provider would set those headers. For instance, the genuine “TP_A” vulnerability scanner generally uses the header “Accept: application/xml,application/xhtml+xml,text/html;q=0.9,text/plain;q=0.8,image/png,*/*;q=0.5”, but the malicious scanner is set to use a different header “Accept: */*;q=1,” instead. By analyzing such discrepancies, the software security agent 106 can determine with a high probability (e.g., greater than 50%, 60%, 75%, 80%, 85%, or more) whether a communication request is received from a malicious user.

Alternatively or in addition, the security agent 106 can determine at step 172 whether the communication is associated with a malicious user interacting with a decoy unit (also called a honeypot). In various embodiments, the decoy unit is not actually related to the operational logic (e.g., business logic) of the application 102, and legitimate users are generally unaware of the existence of the decoy unit or may ignore it. A malicious user, however, who is unaware of the fact that the unit is a decoy, may attempt to exploit the application 102 by changing the value of the decoy unit. In some embodiments, the agent 106 can add a decoy object to a response provided by the application 102 to the user. For example, a cookie called “system_admin” having a value of “false” can be added to an HttpServletResponse. In addition, the agent 106 may provide detection code that can be instrumented and that can detect HttpServletRequests to check if a communication/request from a user changes the value of the cookie to “true.” Typically, only a malicious user would attempt to change the value of a cookie in this manner and, as such, an attempt to change the value of the decoy unit can indicate that the communication/request is likely associated with a malicious user.

The value designated by the security agent 106 to the decoy unit can be a known persistent value, e.g., FALSE, “1,” “100,” etc. The value can also be algorithmic such as a value that is a function of a date, time, and/or a sender's IP address, where only the security agent has knowledge of the function used to compute the value. Users communicating with the application 102 would generally not be aware of the function used for computing the value of the decoy unit. Should a malicious user attempt to change the value, that change would likely be inconsistent with the persistent or algorithmic values. For example, in a replay attack, a malicious user may repeat a previously provided value, whereas a legitimate user would let the application 102 or the agent 106 compute a new value in an algorithmic manner. Detecting such an inconsistent change, the agent 106 can determine that the communication/request is likely received from a malicious user. In some embodiments, any subsequent communication from a user previously determined to be a malicious user may also be determined to be likely from that malicious user.

In some embodiments, a threat level of the communication is determined at step 174. The threat level can be designated as LOW, MEDIUM, or HIGH. If the security agent 106 determines with a high probability (e.g., greater than 50%, 60%, 85%, etc.) that the communication was received from a beneficial scan, the communication may be designated a LOW threat level, in some embodiments. A communication attempting to change the value of a decoy unit, however, may be designated a HIGH threat level. In some embodiments, any subsequent communication from a user previously determined to be a malicious user may be designated a HIGH threat level.

In some embodiments, if the communication is properly encoded, that communication may also be designated a LOW threat level. On the other hand, an improperly encoded communication, which may include one or more escape characters, may be designated a HIGH threat level. As an example, a properly encoded communication/request would include “% 27” whereas a corresponding improperly encoded communication/request would include the single quotation mark (′) character, and can be designated a HIGH threat level. This is because while processing the improperly encoded communication/request, upon encountering the escape character the application 102 can behave in a manner not intended by the developer(s) of the application. This may allow a malicious user to gain access to sensitive data managed by the application and/or to take control of the execution of the application 102.

At step 174, the security agent 106 can check if the communication includes signatures indicative of attacks. If a communication/request includes information/data/commands that can result in code execution, such communication/request can be an attack on the application 102. Examples of such information/data/commands include operating system command injection (identified by common weakness enumeration (CWE) CWE-78), possibility of data loss via SQL injection CWE-89, etc. It should be understood that these examples are illustrative only and, in general, the security agent 106 can inspect the intercepted communication for many different kinds of signatures. The signatures can be classified in formats other than CWE. If a potential attack signature is detected, the security agent 106 can designate that communication as having a HIGH threat level. A communication that is designated neither LOW nor HIGH threat level may be designated the MEDIUM threat level at step 174, in some embodiments. The intercepted communication and the designated threat level may be reported to the system administrator and/or may be logged at step 176, in some embodiments.

In some embodiments, if the security agent 106 determines at step 172 that the probability that the communication is associated with a malicious user is low (e.g., less than 1%, 5%, 15%, 20%, 40%, 50%, etc.), the agent 106 may permit the communication with the application 102 that is to be protected. At step 178, the application 102 may process the communication/request and may prepare the response to send to the user.

If the security agent 106 determines that the probability that the communication is associated with a malicious user is not low (e.g., greater than or equal to 1%, 5%, 15%, 20%, 40%, 50%, etc.), the agent 106 may determine threat level of the communication at step 174, as described above. At step 182, if the threat level is determined to be LOW, the agent 106 may permit the communication with the application 102 that is to be protected. Here again, at step 178, the application 102 may process the communication/request and may prepare to send the response to the user. In some embodiments, the agent 106 can take a similar action if the threat level is determined to be MEDIUM. In some embodiments, at step 182 the agent 106 may block the communication from reaching the application 102, if the threat level is determined to be MEDIUM or HIGH. This can include stopping the execution of the application 102 or diverting the communication to a page informing the likely malicious user that the application 102 is unavailable. An identifier of the user may be recorded and further communications from that user may also be blocked.

A similar analysis can be performed by inspecting the response from the application 102. For example, in some instances, the analysis in step 172 may erroneously determine that the probability that the communication is associated with a malicious user is low, or step 182 may erroneously determine that the threat level is LOW. Therefore, at step 178, the communication/request may be forwarded to the application 102, which may then produce a response to be sent to the user.

This communication/request may take advantage of a vulnerability in the application 102. The application 102 may process this input and may output an error message in the response, which may signal the malicious user that the malicious user is on the right track for exposing and/or exploiting a vulnerability in the application 102. To minimize such occurrences, in some embodiments, the software security agent 106 intercepts and analyzes the results at step 180, before they are sent to the user. In some embodiments, if the security agent 106 determines at step 184 that the probability that the response produced by the application 102 is responsive to a malicious request is low (e.g., less than 1%, 5%, 15%, 20%, 40%, 50%, etc.), the agent 106 may permit the response to be sent to the user at step 192.

If the security agent 106 determines that the probability that the response is responsive to a malicious request is not low (e.g., greater than or equal to 1%, 5%, 15%, 20%, 40%, 50%, etc.), the agent 106 may determine threat level corresponding to the response at step 186. At step 190, if the threat level is determined to be LOW, the agent 106 may permit the response to be sent to the user at step 192. In some embodiments, the agent 106 can take a similar action if the threat level is determined to be MEDIUM. In some embodiments, at step 190 the agent 106 may block the response from reaching the user (who can be a malicious user), if the threat level is determined to be MEDIUM or HIGH. This can include informing the likely malicious user that the application 102 is unavailable. An identifier of the user may be recorded and further communications from that user may also be blocked.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communications protocols to facilitate communications between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communications with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

Accordingly, We claim:

1. A method for detecting attacks on a software application, the method comprising the steps of:
loading a software agent in a runtime environment;
instrumenting by the software agent, in the runtime environment, a component of a software application, the instrumentation comprising inserting a code fragment at an entry location in the software application where the software application can receive data from a user, wherein the code fragment is configured to monitor a data exchanged by the software application;
causing execution of the software application;
intercepting by the software agent a communication between a user and the software application, the interception comprising monitoring at least one of a request for data and a response by the software application to a request for data; and
analyzing by the software agent a threat severity of the communication based on a determination by the software agent of at least one of: (i) whether the communication is associated with a scanner, and (ii) whether the communication is attempting to change a value associated with a decoy unit.

2. The method of claim 1, wherein:
the software agent comprises one or more rules and a code fragment; and
at least one of the one or more rules is configured to detect the entry point.

3. The method of claim 1, wherein the communication comprises at least one of a request received by the software application and a response generated by the software application.

4. The method of claim 1, wherein:
the software agent determines that the communication is associated with a software scanner; and
analyzing the threat severity comprises assigning a designated low threat level to the communication.

5. The method of claim 1, wherein:
the software agent determines that the communication is not associated with a scanner; and
analyzing the threat severity comprises assigning a designated high threat level to the communication.

6. The method of claim 1, wherein:
the communication is associated with a decoy unit; and
analyzing the threat severity comprises assigning a threat level to the communication based on, at least in part, an attempted change in a value corresponding to the decoy unit.

7. The method of claim 6, wherein:
the value corresponding to the decoy unit comprises a persistent value; and
detecting the attempted change comprises determining that the communication associated with the decoy unit comprises a value different from the persistent value.

8. The method of claim 6, wherein:
the value corresponding to the decoy unit comprises a programmatically computed value; and
detecting the attempted change comprises determining that the communication associated with the decoy unit comprises a value different from the programmatically computed value.

9. The method of claim 6, wherein the decoy unit comprises at least one of a cookie unrelated to business logic of the software application and an interactive service unrelated to the business logic.

10. The method of claim 6, further comprising instantiating by the software agent the decoy unit in association with the software application, in the runtime.

11. The method of claim 1, further comprising blocking the communication based on, at least in part, a threat level assigned to the communication by the software agent.

12. A system for detecting attacks on a software application, the system comprising:
a first processor; and
a first memory in communication with the first processor, the first memory comprising instructions which, when executed by a processing unit comprising at least one of the first processor and a second processor, the processing unit being in communication with a memory module comprising at least one of the first memory and a second memory, program the processing unit to:
load a software agent in a runtime environment;
instrument by the software agent, in the runtime environment, a component of a software application, the instrumentation comprising inserting a code fragment at an entry location in the software application where the software application can receive data from a user, wherein the code fragment is configured to monitor a data exchanged by the software application;
initiate execution of the software application;
intercept by the software agent a communication between a user an the software application, the interception comprising monitoring at least one of a request for data and a response by the software application to a request for data; and
analyze by the software agent a threat severity of the communication based on a determination by the software agent of at least one of: (i) whether the communication is associated with a scanner, and (ii) whether the communication is attempting to change a value associated with a decoy unit.

13. The system of claim 12, wherein:
the software agent comprises one or more rules and a code fragment; and
at least one of the one or more rules is configured to detect the entry point.

14. The system of claim 12, wherein the communication comprises at least one of a request received by the software application and a response generated by the software application.

15. The system of claim 12, wherein:
the software agent determines that the communication is associated with a software scanner; and
to analyze the threat severity, the instructions program the processing unit to assign a designated low threat level to the communication.

16. The system of claim 12, wherein:
the software agent determines that the communication is not associated with a scanner; and
to analyze the threat severity, the instructions program the processing unit to assign a designated high threat level to the communication.

17. The system of claim 12, wherein:
the communication is associated with a decoy unit; and
to analyze the threat severity, the instructions program the processing unit to:
assign a threat level to the communication based on, at least in part, the attempted change in the value corresponding to the decoy unit.

18. The system of claim 17, wherein:
the value corresponding to the decoy unit comprises a persistent value; and
to detect the attempted change, the instructions program the processing unit to determine that the communication associated with the decoy unit comprises a value different from the persistent value.

19. The system of claim 17, wherein:
the value corresponding to the decoy unit comprises a programmatically computed value; and
to detect the attempted change, the instructions program the processing unit to determine that the communication associated with the decoy unit comprises a value different from the programmatically computed value.

20. The system of claim 17, wherein the decoy unit comprises at least one of a cookie unrelated to business logic of the software application and an interactive service unrelated to the business logic.

21. The system of claim 17, wherein the instructions further program the processing unit to instantiate, via the software agent, the decoy unit in association with the software application, in the runtime.

22. The system of claim 12, wherein the instructions further program the processing unit to block the communication based on, at least in part, a threat level assigned to the communication by the software agent.
